(19) United States
(12) Patent Application Publication
(10) Pub. No.: US 2021/0218039 A1
(43) Pub. Date: Jul. 15, 2021

(54) BOX-IN-BOX STRUCTURE COMPRISING THERMAL CLAY, USE OF THE SAME AND METHOD TO FORM THE SAME

(71) Applicants: Rong-Jie Chen, New Taipei City (TW); Chih Hung Lin, San Jose, CA (US)

(72) Inventors: Rong-Jie Chen, New Taipei City (TW); Chih Hung Lin, San Jose, CA (US)

(21) Appl. No.: 17/015,102

(22) Filed: Sep. 9, 2020

Related U.S. Application Data
(60) Provisional application No. 62/961,152, filed on Jan. 14, 2020.

(51) Int. Cl. H01M 8/0273; B29C 64/118; B33Y 70/00; B33Y 80/00; H01M 8/0284

(52) U.S. Cl. CPC H01M 8/0273; B29C 64/118; B29K 2081/06; B33Y 80/00; H01M 8/0284; B33Y 70/00

(57) ABSTRACT

A box-in-box structure includes thermal clay, a plate and a film. The thermal clay includes a polyarysulfone material. The thermal clay is in a form of a first box and the film which has at least one side is in a form of a second box. The second box is attached to the first box in the presence of the plate so that the first box accommodates the second box to form a box-in-box structure.

### CROSS REFERENCE TO RELATED APPLICATIONS

This application claims priority to Provisional Application No. 62/961,152, filed on Jan. 14, 2020. The contents thereof are included herein by reference.

### BACKGROUND OF THE INVENTION

### 1. Field of the Invention

The present invention generally relates to a box-in-box structure including a thermal clay, use of a thermal clay, use of the box-in-box structure and a method to form a box-in-box structure. In particular, the present invention is directed to a box-in-box structure including thermal clay to attach a second box to a first box for use in a fuel cell or in a cell assembly.

### 2. Description of the Prior Art

A fuel cell is an electronic device which converts the chemical potential energy which is stored in the molecules of the fuel into electrical energy in the form of an electrical current by means of a controlled chemical reaction. Because oxygen gas is readily available in the atmosphere, all the things which the fuel cell need are the supply of the fuel.

A fuel cell usually includes an anode, a cathode, a membrane to separate the anode and the cathode, and a film for oxygen molecules to pass through. A perfluoropolymer may be used to serve as the film for its excellent chemical resistance and stability but the intrinsic anti-stick property of the perfluoropolymer makes it often weakly and inadequately attached to a metallic material. This results in inadequate mechanical strength between the interface of the organic polymer and the metallic material and furthermore, it is adverse to the application of the perfluoropolymer to a fuel cell so it is urgently needed in the industry to propose a novel solution as well as to provide a novel fuel cell or a novel cell assembly with an excellent or more stable mechanical property for more and wider industrial applications in the future.

### SUMMARY OF THE INVENTION

In the light of the above, the present invention proposes a novel box-in-box structure including thermal clay, the use of a thermal clay to greatly enhance the mechanical strength between the interface of an organic polymer or of a metallic material, the use of the box-in-box structure in a fuel cell or in a cell assembly and a method to form a box-in-box structure. In some embodiments, the present invention proposes a novel box-in-box structure for use in a fuel cell or in a cell assembly with an excellent or more stable mechanical property.

The present invention in a first aspect proposes a box-in-box structure. The box-in-box structure includes thermal clay, a plate, and a film. The thermal clay includes a polyarysulfone material. The thermal clay may be in a form of a first box. The film may have at least one side. The film may be in a form of a second box to be attached to the first box in the presence of the plate so that the first box may accommodate the second box to form the box-in-box structure.

In one embodiment of the present invention, the polyarysulfone material may be selected from a group consisting of a polysulfone, a polyethersulfone and a polyphenylsulfone.

In another embodiment of the present invention, the plate may be selected from a metallic group consisting of a stainless steel, Ni, Fe, brass and an aluminum alloy.

In another embodiment of the present invention, the film may be a perfluoropolymer organic film.

In another embodiment of the present invention, the film may be in direct contact with the first box. The thermal clay may keep the bonding strength between the first box and the second box not less than 15 kgf (147 Newtons) in accordance with IEC68-2-21 Test Ua1.

The present invention in a second aspect proposes a method to form a box-in-box structure. The method may include at least the following steps. Thermal clay in a form of a first box may be provided. A film which has at least one side in a form of a second box may be provided. The thermal clay including a polyarysulfone material may be applied to attach the second box to the first box so that the second box is accommodated in the first box to form a first box-in-box structure.

In one embodiment of the present invention, the thermal clay may be applied by a fused deposition modeling printer.

In another embodiment of the present invention, the thermal clay may have a temperature from 300° C. to 400° C. and may be softened to be printed.

In another embodiment of the present invention, the thermal clay may be applied and stacked on another thermal clay to form a thermal-clay-on-thermal-clay structure.

In another embodiment of the present invention, an interface temperature between the first box and the second box may be from 100° C. to 150° C.

In another embodiment of the present invention, the method to form a box-in-box structure may further include the following steps. An electrode may be provided to be covered by the film. A conductive sheet may be provided to be electrically connected to the plate. An insolation film may be provided to be connected to the plate.

In one embodiment of the present invention, the method to form a box-in-box structure may further include the following steps. A second box-in-box structure may be provided. The second box-in-box structure may be connected to the first box-in-box structure to form a cell.

In one embodiment of the present invention, the cell may include at least two box-in-box structures.

The present invention in a third aspect proposes a box-in-box structure for use in a fuel cell. The box-in-box structure includes thermal clay, a film, a plate, and further includes an isolation film to form a fuel cell.

The present invention in a fourth aspect proposes thermal clay including a polyarysulfone material and a film for use in a fused deposition modeling printer for the formation of a box-in-box structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a top view of an embodiment of the box-in-box structure of the present invention.

FIG. 2 illustrates a side view of a first embodiment of the box-in-box structure of the present invention.

FIG. 3 illustrates some polyarysulfone materials for use as the thermal clay of the present invention.

FIG. 4 illustrates an embodiment of using a printer for the application of thermal clay for the formation of a box-in-box structure of the present invention to form a thermal-clay-on-thermal-clay structure.

FIG. 5 illustrates an embodiment of the method to form a box-in-box structure of the present invention.

FIG. 6 illustrates an embodiment of an explosive diagram of a cell structure which includes the box-in-box structure of the present invention.

FIG. 7 illustrates an embodiment of the formation of a central module structure in accordance with the method of the present invention.

FIG. 8 illustrates an embodiment of the formation of a first module or a second module in accordance with the method of the present invention.

FIG. 9 illustrates an embodiment of the assembly of a cell which includes the box-in-box structure of the present invention.

FIG. 10 illustrates an embodiment of a cell assembly of multiple cells which include the box-in-box structure of the present invention.

### DETAILED DESCRIPTION

As one skilled in the art will understand, electronic equipment manufacturers may refer to a component by different names. This document does not intend to distinguish between components that differ in name but not function. In the following description and in the claims, the terms “include”, “comprise” and “have” are used in an open-ended fashion, and thus should be interpreted to mean “include, but not limited to”. When an element or layer is referred to as being “on” or “connected to” another element or layer, it may be directly on or directly connected to the other element or layer, or intervening elements or layers may be presented. Although terms such as first, second, third, etc., may be used to describe diverse constituent elements, such constituent elements are not limited by the terms. The terms are used only to discriminate a constituent element from other constituent elements in the specification. The claims may not use the same terms, but instead may use the terms first, second, third, etc. with respect to the order in which an element is claimed. Accordingly, in the following description, a first constituent element may be a second constituent element in a claim.

The numeral value ranges within the maximum and minimum values or further obtained from the combination ratio relationships of the parameters disclosed in the specification of the invention may all be implemented accordingly.

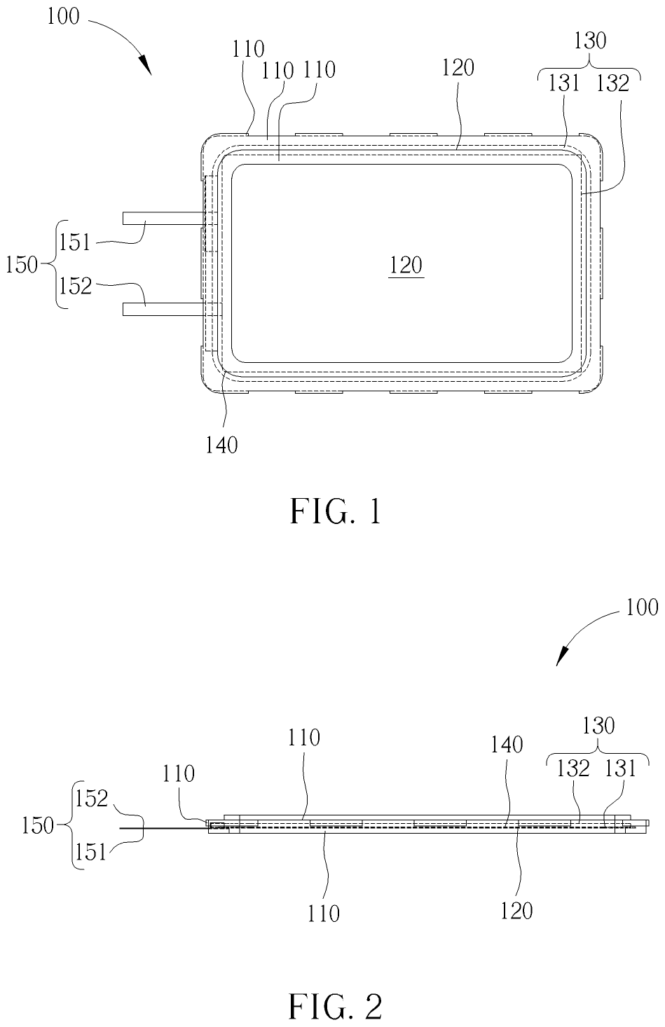

The present invention in a first aspect provides a box-in-box structure with an excellent or more stable mechanical property. FIG. 1 illustrates a top view of a first embodiment of the box-in-box structure of the present invention. FIG. 2 illustrates a side view of a first embodiment of the box-in-box structure of the present invention. Please refer to FIG. 1 or to FIG. 2, the box-in-box structure 100 may include thermal clay 110, a film 120 and a set of plates 130. The box-in-box structure 100 may further include an isolation film 140 and a pair of conductive sheets 150.

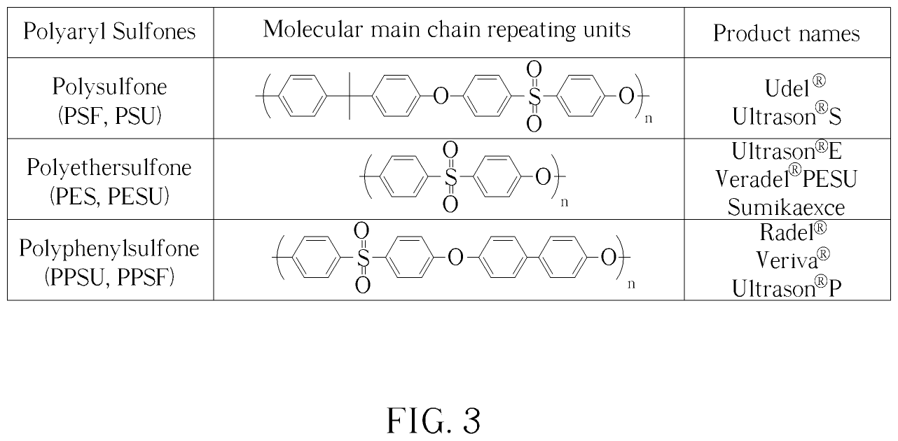

The thermal clay 110 may be in a form of a first box to serve as an outer box of the box-in-box structure 100, or a frame of the box-in-box structure 100. The thermal clay 110 may include a polyarysulfone material to enhance the mechanical strength between the interface of an organic polymer and of a metallic material. The polyarysulfone material may be the thermoplastics with sulfonyl groups. In one embodiment of the present invention, the polyarysulfone material may be selected from a group consisting of polysulfones (PSF, PSU), polyethersulfones (PES, PESU), polyarylethersulfones (PAES) and polyphenylenesulfones (PPSU, PPSF). FIG. 3 illustrates some polyarysulfone materials for use as the thermal clay of the present invention, but the present invention is not limited to these.

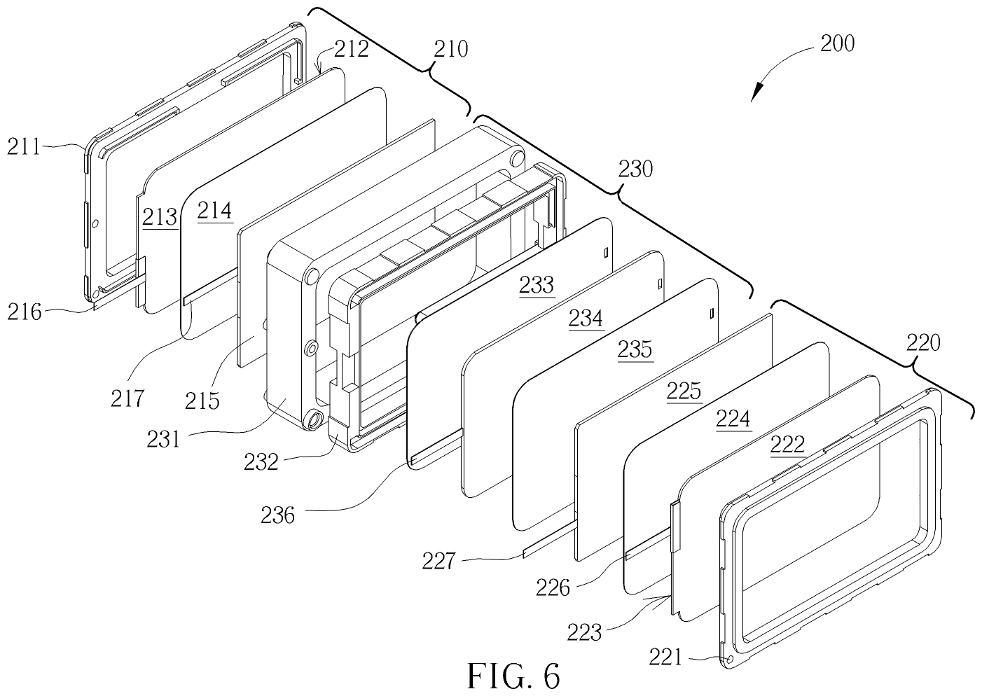

The film 120 may have at least one side, for example four sides to be a rectangular shape (See FIG. 6). The film 120 may be an organic polymeric material, such as a perfluoropolymer organic film. The film 120 may be in a form of a second box in terms of a rectangular shape to serve as the inner box of the box-in-box structure 100 so that the first box accommodates the second box to form a box-in-box structure 100. The film 120 may have good gas permeability which allows one or more gas permeates through the membrane. In particular, the film 120 may allow oxygen gas to permeate through the membrane. Table 1 shows some physical properties of the film 120.

TABLE 1

| | | Analysis | | | Judgment Method | |
|---|---|---|---|---|---|---|
| Item | Unit | Min. | Max. | Average | or condition | |
| Thickness | mm | 0.02 | 0.24 | 0.23 | OK | Dial Gauges |
| | | | | | | (Membrane only) |
| Gurley | sec | 2.0 | 15 | 11.0 | OK | JIS P8117 |
| | | | | | | (100 cc/in 2 @ |
| | | | | | | 1.23 kPa) |
| Water Entry | MH₂O | >5 | | | OK | JIS L1092 |
| Pressure | | | | | | |

The set of plates 130 may include two plates, a plate 131 and a plate 132 for example. Each plate 131 and plate 132 may include a metallic material, such as a metal or an alloy, a filler and a catalytic material to serve as an electric plate or an electrode. For example, the metallic material may include stainless steel, Ni, Fe, brass and an aluminum alloy, but the present invention is not limited to these. The set of plates 130 may include a porous (90 to 110 PPI) foam metal electrode sheet with the filler in the holes of the set of plates 130. The filler may include conductive carbon black, but the present invention is not limited to these. The catalytic material may be a metal powder material of chemical activity, such as a catalytic metal, for example cobalt or manganese, but the present invention is not limited to these. One plate may serve as an anode of the box-in-box structure 100 fora suitable chemical half-reaction, and the other plate may serve as a cathode of the box-in-box structure 100 for another suitable chemical half-reaction.

The film 120 may be attached to the plate 130 in the presence of the thermal clay 110. In other words, the thermal clay 110 of the first box may be in direct contact with the second box of the film 120 and with the plate 130 to a keep a bonding strength between the first box and the second box. The bonding strength between the first box and the second box may be not less than 15 kgf in accordance with IEC68-2-21 Test Ua1.

The isolation film 140 may include an insulating material to electrically segregate two adjacent plates 131/132. A pair of conductive sheets 150 may include a first conductive sheet 151 and a second conductive sheet 152. The first conductive sheet 151 and the second conductive sheet 152 may be respectively electrically connected to the corresponding plate 131/132. The first conductive sheet 151 may be a nickel sheet with insulation treatment on its surface, but the present invention is not limited to this. Similarly, the second conductive sheet 152 may be a nickel sheet with insulation treatment on its surface, but the present invention is not limited to this. The first conductive sheet 151 which is electrically connected to the anode may serve as an anode electrode of the box-in-box structure 100. The second conductive sheet 152 which is electrically connected to the cathode may serve as a cathode electrode of the box-in-box structure 100.

The thermal clay in the box-in-box structure may serve as an adhesive to make the film of the second box adequately attached to the thermal clay of the first box with sufficient bonding stress. The thermal clay is a robust solid at ambient temperature with strong affinity to the plate and to the film but the thermal clay is soft enough and becomes clay-like at high temperature, for example from 300° C. to 400° C. or around its glass transition temperature (Tg), so the thermal clay may be applied to or printed on the surface of an object regardless of the material of the object under a thermal (heated) condition like clay to attach the film firmly onto the thermal clay. The operational temperature at the interface of the thermal clay and the film for printing may be in a range from 100° C. to 150° C.

For example, the thermal clay 110 may be used or formed in a printer such as a 3D printer, for example applied by a fused deposition modeling printer 300. The thermal clay 110 may include a polyarysulfone material. The printer 300 may be useful in the formation of a pre-determined shape or of an object in an article, for example to form a fuel cell such as the box-in-box structure 100 in FIG. 1 or in FIG. 2.

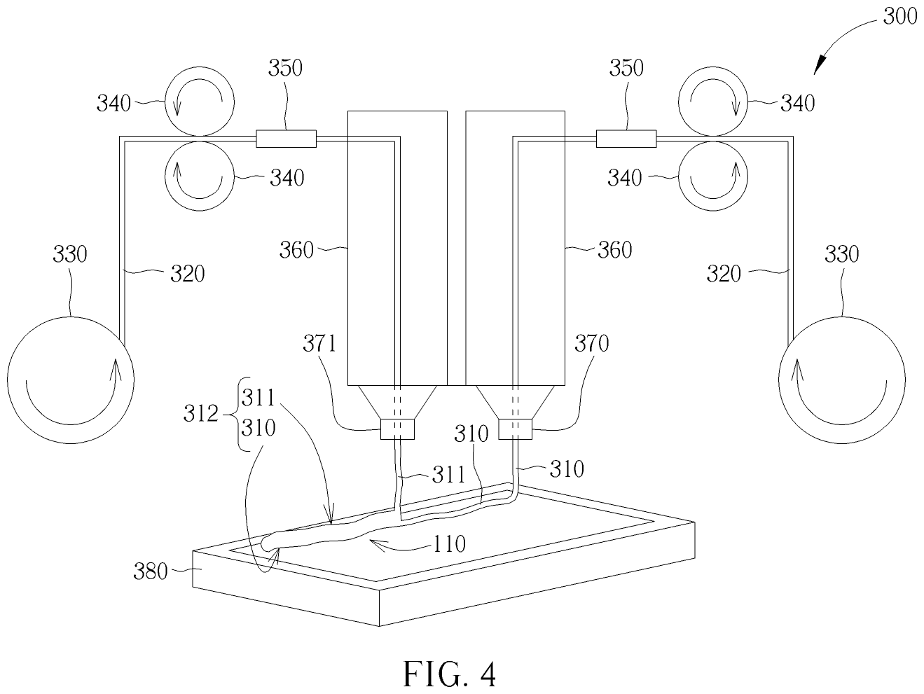

In one embodiment of the present invention, the thermal clay may be heated, for example may have a temperature from 300° C. to 400° C., to be softened for printing. In another embodiment of the present invention, as shown in FIG. 4, the thermal clay 311 may be applied and stacked on another layer of thermal clay 310 to form a thermal-clay-on-thermal-clay structure 312. The thermal-clay-on-thermal-clay structure 312 may be in a form of a rectangular shape or in a form of a box for use as the box-in-box structure 100.

The printer 300 may include one or more support material cartridges 330, drive wheels 340, one or more liquefiers 350, one or more heater blocks 360 and one or more tips 370/371. The filaments of the thermal clay polymer resin 320 may be supplied by the support material cartridge 330, passes through the drive wheels 340 and the liquefier 350 to become a liquid, as shown in FIG. 4. The liquid which has a temperature from 300° C. to 400° C. then may be dispensed by the tip 370 of the heater block 360 to be applied on an object 380 or applied on another layer of thermal clay 310 to form a thermal-clay-on-thermal-clay structure 312. The printer 300 may include one tip 370. For example, one tip 370 may apply the thermal clay polymer resin 320 in a liquid state on the object 380 or on another layer of thermal clay 310 to form a thermal-clay-on-thermal-clay structure 312.

Or alternatively, the printer 300 may include a tip 370 and a tip 371. The tip 371 may apply the thermal clay 311 in a liquid state on the object 380 or on another layer of thermal clay 310 which is provided by a different tip 370 to form a thermal-clay-on-thermal-clay structure 312. FIG. 4 illustrates an embodiment of a printer 300 including a tip 370 and a tip 371, but the present invention is not limited to this.

A fused deposition FDM (fused deposition modeling) for the application of a high-temperature thermal clay polymer resin is the most widely used 3D printing technology. FDM 3D printing technology may use solid thermoplastic filaments of polysulfone resins to print objects. The polysulfone resins melt when they passes through the heated nozzle, and then the printer drives the nozzle continuously to dispense the melted material in a precise position according to the predetermined path. When the polymer resin is printed, it is fused together due to the relative thermal fusion of the polymer resin so the material may achieve a dense melting fusion which an ordinary 3D FDM printing material is unable to achieve. It is extremely shapeable under high temperature applications. Therefore, after the polymer resin is printed and cools down, the material is resultantly fused together and tightly integrated in a solid form with no visible gaps to be visually and/or physically seamless which is common in traditional 3D FDM. The integrated fusion may be a caulking-type fusion, i.e. there are no bubbles as a result of the integrated fusion or it is not a fake fusion which mini-gaps are present. Accordingly, the strength of the solidified stacking layers of the material by the FDM 3D printing method is much greater than that of other materials for use in 3D FDM printing. The characteristics of polysulfone-type thermal clay are undoubtedly exceptional for FDM 3D printing.

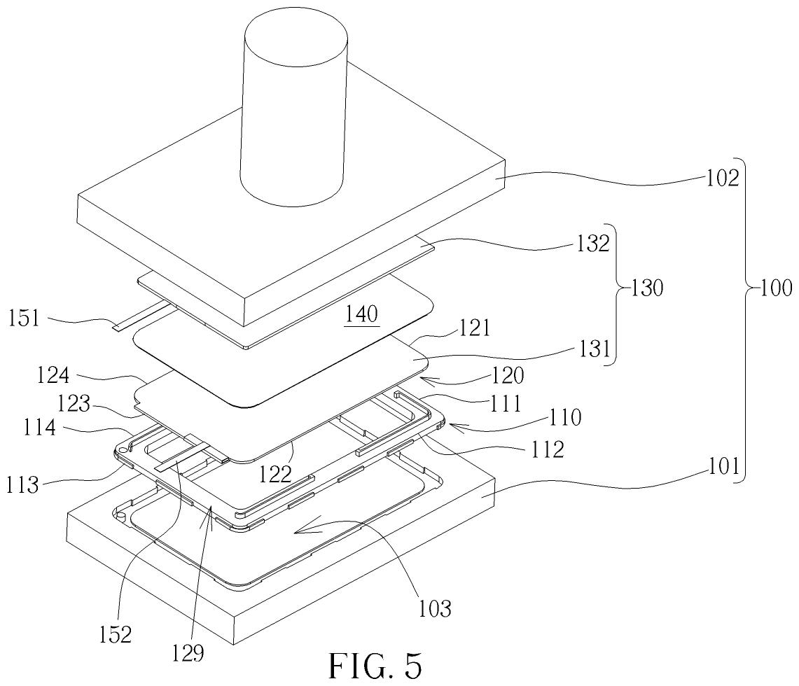

The present invention in a third aspect provides a method to form a box-in-box structure. FIG. 5 illustrates an embodiment of the method to form a box-in-box structure. As shown in FIG. 5, the thermal clay 110, a film 120, a plate 131, a plate 132 and an isolation film 140 are provided in a hot press machine 100.

The thermal clay 110 may be in a form of a rectangular shape or in a shape of a box with four sides, for example a side 111, a side 112, a side 113, a side 114 to serve as a first box. The FDM 3D printing method may be used for forming the thermal clay 110 of the pre-determined shape so the thermal clay 110 in a shape of a box may include the thermal-clay-on-thermal-clay structure 312. The thermal clay 110 may include a polyarysulfone material. Please refer to the above descriptions for the details of the thermal clay 110.

The film 120 may have at least one side, for example four sides to be a rectangular shape, for example a side 121, a side 122, a side 123, a side 124 to serve as a second box. The film 120 may be an organic polymeric material, such as a perfluoropolymer organic film. The shape and the size of the film 120 may correspond to those of the thermal clay 110. Please refer to the above descriptions for the details of the film 120.

The set of plates 130 may include a plate 131 and a plate 132. Each plate 131 and plate 132 may be an electric plate or an electrode for a chemical half-reaction, for example chemical half-reactions of an air cell or a fuel cell. One of the plate 131 and plate 132 may serve as a cathode and the other may serve as an anode. Please refer to the above for the descriptions of the plate 131 and the plate 132 so the details are not elaborated here.

As shown in FIG. 5, an isolation film 140 and a conductive sheet may further be provided. The conductive sheet may be electrically connected to the plate, for example the first conductive sheet 151 may be electrically connected to the plate 132 and the second conductive sheet 152 may be electrically connected to the plate 131. The isolation film 140 may be disposed between the plate 131 and the plate 132 to segregate the anode and the cathode of a cell. The shape and the size of the isolation film 140, the plate 131 and the plate 132 may correspond to those of the thermal clay 110. Please refer to the above for the descriptions of the isolation film 140, the plate 131 and the plate 132 so the details are not elaborated here.

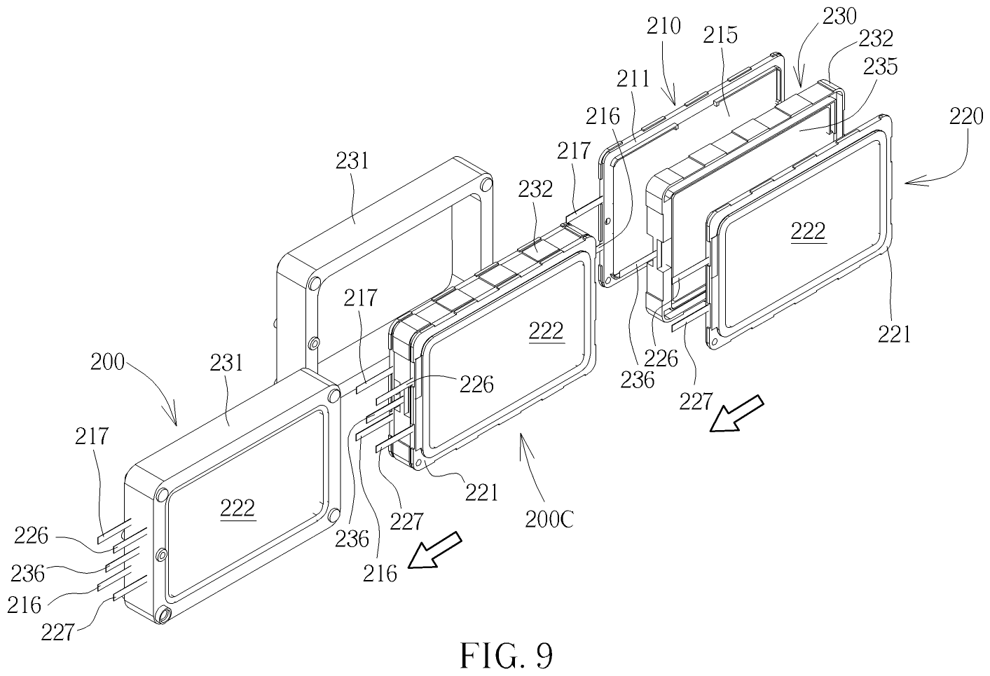

The printed thermal clay 110, the film 120, the plate 131, the isolation film 140 and the plate 132 may be permanently combined together by various approaches, for example performing a heat-generating welding approach such as hot welding method, ultrasonic welding method or a combination thereof in no specific order, but the present invention is not limited to these, for the formation of the box-in-box structure 100. Further, the heat-generating welding for the formation of a box-in-box structure may be optionally combined with the insert molding method for the formation of a single cell structure 200 or a single battery structures (as shown in FIG. 9). For example, one or more welding method may be optionally combined with the insert molding method to obtain an integrated product with no visible overlapping gaps to be visually and/or physically seamless.

A hot welding method is given as an example as follows, but the present invention is not limited to this. A hot press machine 100 is provided for the formation of a box-in-box structure. The hot press machine 100 may include two hot press plates, for example a first hot press plate 101 and a second hot press plate 102. Each hot press plate may provide thermal energy, for example high temperature, to melt the thermal clay 110 for pressing all the components together and to keep all the components tightly combined together with the help of the thermal clay 110 from falling apart. In other words, the thermal clay 110 may work as an outer box, an outer frame, an outer support and an adhesive in the box-in-box structure 100 for use in a cell or in a battery. At least one hot press plate, for example the first hot press plate 101 may have a recess 103 to accommodate the thermal clay 110.

The printed thermal clay 110, the film 120, the plate 131, the isolation film 140 and the plate 132 in stack may be individually provided in the hot press machine 100 in order, as shown in FIG. 5, for the formation of a box-in-box structure. The thermal clay 110 may be accommodated in the recess 103 of the first hot press plate 101. Next, the first hot press plate 101 and the second hot press plate 102 press the printed thermal clay 110, the film 120, the plate 131, the plate 132 and the isolation film 140 together. The first hot press plate 101 and the second hot press plate 102 may provide sufficient thermal energy, high temperature for example, to melt the printed thermal clay 110. Then the melted printed thermal clay 110 may then fix the film 120, the plate 131, the plate 132 and the isolation film 140 together in a temperature range about 300° C. to 320° C. for example, to form a box-in-box structure. In one embodiment of the present invention, the temperature around an interface 129 between the first box (the thermal clay 110) and the second box (the film 120) may be from 100° C. to 150° C., but the present invention is not limited to this.

The film 120 may undergo an optional pre-treatment procedure before the application of thermal clay. The pre-treatment procedure may increase the adhesion of the film 120 to the thermal clay 110. For example, the pre-treatment procedure may include at least one of a surface roughness treatment or a primer treatment procedure. A conventional surface roughness treatment may be suitable. The film 120 which may undergo a surface roughness treatment may have surface energy 50 mN/m (Dynes) or higher. For example, a dyne pen test may be used for the determination of the surface energy of the film 120 after the surface roughness treatment. A primer may be applied to the film 120 for the primer treatment procedure. For example, a primer such as Loctite 770, Loctite 7701, Weicon Contact-Primer for Polyolefins, Radiant 3770 Primer may be used, but the present invention is not limited to these.

Then, the thermal clay 110 including a polyarysulfone material may help form the box-in-box structure 100 as shown in FIG. 1 or in FIG. 2. The thermal clay helps the film firmly attach to the thermal clay so that the second box is tightly accommodated in the first box to form the first box-in-box structure 100. Please refer to FIG. 3 for the polyarysulfone materials of the thermal clay 110 so the details are not elaborated here.

Accordingly, the present invention in a fourth aspect provides the use of a box-in-box structure in a cell structure, for example in a fuel cell. FIG. 6 illustrates an embodiment of the use of a box-in-box structure in a cell structure.

FIG. 6 illustrates an embodiment of an explosive diagram of a cell structure which includes the box-in-box structure of the present invention for use in a cell structure. For example, a cell structure 200 may include a first module 210, a second module 220 and a central module 230.

At least one of the first module 210 and the second module 220 may correspond to the box-in-box structure of the present invention. In other words, the cell structure 200 may include at least two box-in-box structures. For example, the first module 210 may include a first outer box 211, a first module film 212, a first outer plate 213, a first isolation film 214, a first inner plate 215, a first outer conductive sheet 216 and a first inner conductive sheet 217. The first outer box 211 may include a polyarysulfone material to correspond to the thermal clay 110. The first module film 212 may include a perfluoropolymer organic film to correspond to the film 120. The first outer plate 213 or the first inner plate 215 may include a metallic material to correspond to the plate 131/132. The first isolation film 214 may include an insulating material to correspond to the isolation film 140. The first outer conductive sheet 216 or the first inner conductive sheet 217 may be a nickel sheet with insulation treatment to correspond to one conductive sheet in a pair of conductive sheets 150. The first outer conductive sheet 216 may be electrically connected to the first outer plate 213. The first inner conductive sheet 217 may be electrically connected to the first inner plate 215.

For example, the second module 220 may include a second outer box 221, a second module film 222, a second outer plate 223, a second isolation film 224, a second inner plate 225, a second outer conductive sheet 226 and a second inner conductive sheet 227. The second outer box 221 may include a polyarysulfone material to correspond to the thermal clay 110. The second module film 222 may include a perfluoropolymer organic film to correspond to the film 120. The second outer plate 223 or the second inner plate 225 may include a metallic material to correspond to the plate 131/132. The second isolation film 224 may include an insulating material to correspond to the isolation film 140. The second outer conductive sheet 226 or the second inner conductive sheet 227 may be a nickel sheet with insulation treatment to correspond to one conductive sheet in a pair of conductive sheets 150. The second outer conductive sheet 226 may be electrically connected to the second outer plate 223. The second inner conductive sheet 227 may be electrically connected to the second inner plate 225. Please refer to the above descriptions for the details of the box-in-box structure of the present invention.

The central module 230 may include an optional case 231, a carrier 232, a first central isolation film 233, a central electrode 234, a second central isolation film 235 and a central conductive sheet 236. For example, the optional case 231 may include a polyarysulfone material to correspond to the thermal clay. The optional case 231 may be used to accommodate the carrier 232, the first central isolation film 233, the central electrode 234, the second central isolation film 235 and the central conductive sheet 226. Further, the optional case 231 may be used to accommodate the first module 210, the second module 220 and the carrier 232. The carrier 232 may include a polyarysulfone material to correspond to the thermal clay. The carrier 232 may be used to accommodate the first central isolation film 233, the central electrode 234 and the second central isolation film 235. The first central isolation film 233 or the second central isolation film 235 may include an insulating material to correspond to the isolation film 140. The central electrode 234 may include a metallic material to correspond to the plate. The central conductive sheet 226 may be electrically connected to the central electrode 234. The central conductive sheet 226 may be a nickel sheet with insulation treatment to correspond to one conductive sheet in a pair of conductive sheets. Please refer to the above descriptions for the details.

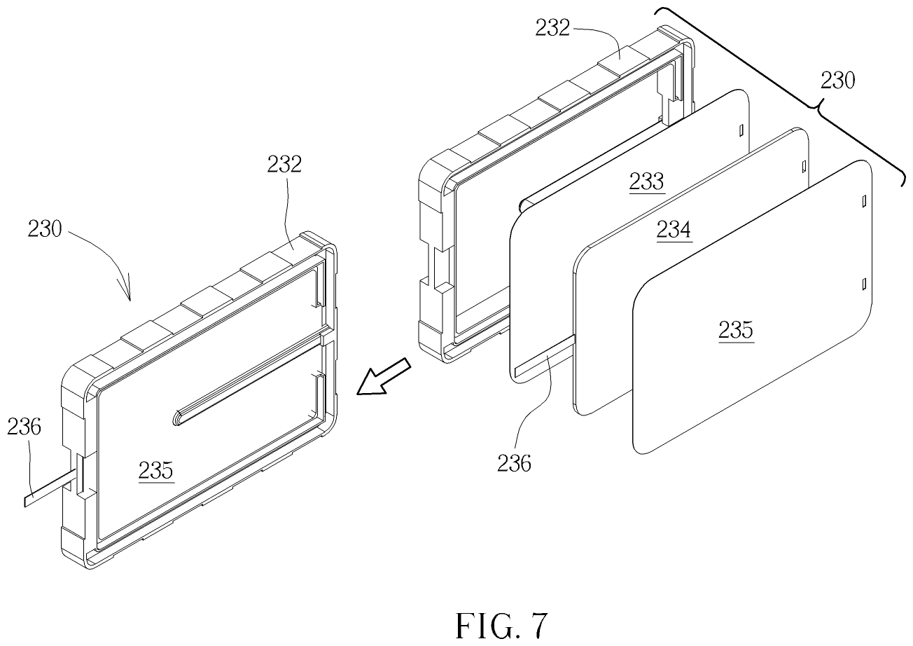

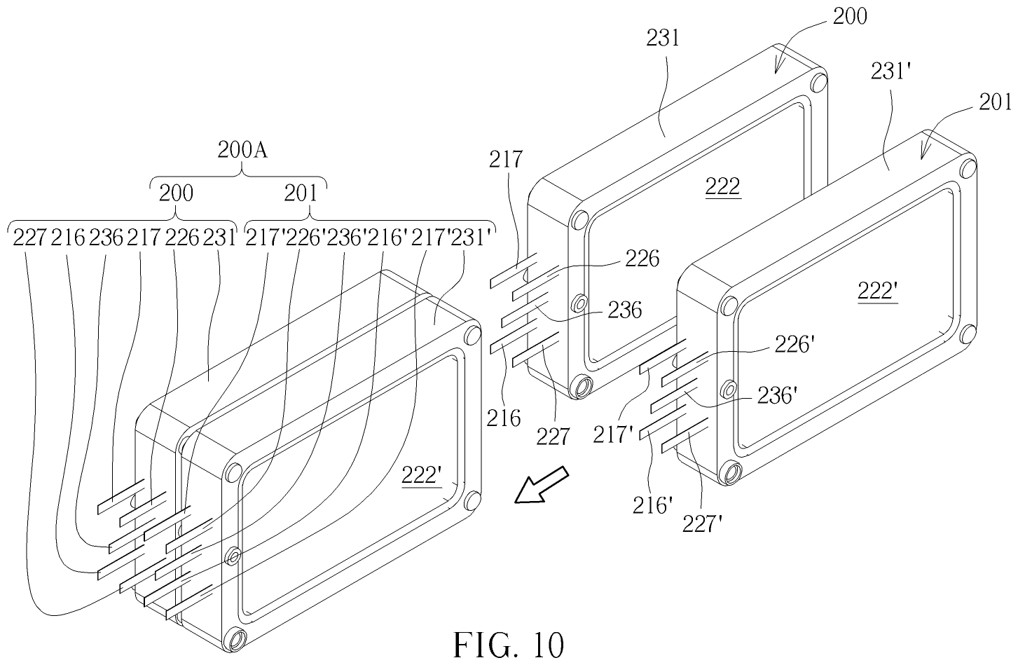

FIG. 7 illustrates an embodiment of the formation of a central module structure in accordance with the method of the present invention. As shown in FIG. 7, the carrier 232, the first central isolation film 233, the central electrode 234, the second central isolation film 235 and the central conductive sheet 226 may be individually provided in a hot press machine (not shown). Next, the first hot press plate (not shown) and the second hot press plate (not shown) may press the carrier 232, the first central isolation film 233, the central electrode 234, the second central isolation film 235 and the central conductive sheet 226 together in the presence of sufficient thermal energy, high temperature for example, to melt the carrier 232. The melted carrier 232 then may then fix the first central isolation film 233, the central electrode 234, the second central isolation film 235 and the central conductive sheet 226 together to form a robust central module 230 structure as shown in FIG. 10.

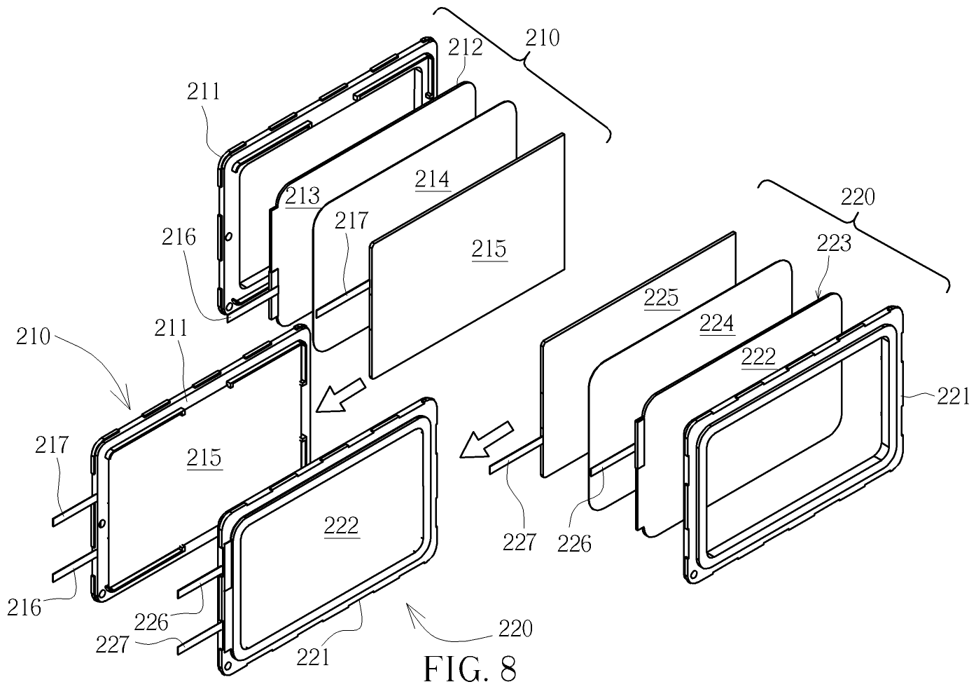

FIG. 8 illustrates an embodiment of the formation of a first module 210 or a second module 220 in accordance with the method of the present invention. As shown in FIG. 8, a first module 210 or a second module 220 may be individually provided, for example in a hot press machine (not shown). For example, the first module 210 may include individual elements, such as a first outer box 211, a first module film 212, a first outer plate 213, a first isolation film 214, a first inner plate 215, a first outer conductive sheet 216 and a first inner conductive sheet 217. The second module 220 may include individual elements, such as a second outer box 221, a second module film 222, a second outer plate 223, a second isolation film 224, a second inner plate 225, a second outer conductive sheet 226 and a second inner conductive sheet 227.

Next, the first hot press plate (not shown) and the second hot press plate (not shown) may press the individual elements of the first module 210 or of the second module 220 together in the presence of sufficient thermal energy, high temperature for example, to melt the first outer box 211 or to melt the second outer box 221. Then the melted outer box may fix the other elements tightly together to form a robust first module 210 structure or a robust second module 220 structure.

After the first module structure, the second module structure and the central module structure are respectively obtained, then the three individual modules may be assembled together to obtain a cell structure or a battery structure. FIG. 9 illustrates an embodiment of the formation of a core structure of a cell structure or of a battery structure in accordance with the method of the present invention. As shown in FIG. 9, an assembled first module 210, an assembled second module 220 and a central module 230 may be individually provided. Next, the assembled first module 210, the assembled second module 220 or the central module 230 may be engaged together. The engagement of the modules may have different embodiments. For example, in a first embodiment, the central module 230 may be engaged with one of the assembled first module 210 and the assembled second module 220; later the central module 230 is engaged with the other assembled module. In a second embodiment, the central module 230 may be engaged with the assembled first module 210 and with the assembled second module 220 with no priority. Each module may have a complementary structure to facilitate the mutual engagement to obtain a core structure 200C. The core structure 200C may be subjected to thermal pressing, for example in a hot press machine to facilitate the air tightness of the core structure 200C.

After the mutual engagement and the thermal pressing, the assembled first module 210, the assembled second module 220 and the central module 230 may be combined together. For example, the core structure 200C may be further jointed to a case 231 using a conventional insert molding method to obtain a single cell structure 200 or a single battery structure. A cell structure 200 or a battery structure may be suitable for the application in an air cell or in a fuel battery. The insert molding method facilitates the air tightness of the cell structure 200, i.e. a cell, for the application in an air cell or in a fuel battery.

After the above steps, a single cell structure 200 or a single battery structure may be obtained. A single cell structure 200 or a single battery structure may include a first module 210, a second module 220 and a central module 230. At least one of the first module 210 and the second module 220 may include a box-in-box structure which at least has thermal clay, a film, two plates, two conductive sheets and an isolation film which electrically segregates the plates. The film may serve as a second box to be tightly attached to the thermal clay in a shape of a first box. In some embodiments, a first box-in-box structure may be electrically connected to a second box-in-box structure.

In addition, one or more cell structures 200 or battery structures may be physically or electrically connected to each other or to one another to form a cell assembly. For example, a cell including a first box-in-box structure may be electrically connecting to another cell including a second box-in-box structure, or further electrically connecting to another cell including a third box-in-box structure to forma cell assembly so that the cell assembly may include one or more box-in-box structures.

FIG. 10 illustrates an embodiment of a cell assembly composed of multiple cells which include at least one box-in-box structure of the present invention. FIG. 10 illustrates an embodiment of a cell structure 200 along with a cell structure 201 to form a cell assembly 200A, but the present invention is not limited to this. For example, a cell assembly 200A may include two or more cell structures, but the present invention is not limited to this. The cell structure 200 may include a first box-in-box structure. The cell structure 201 may include a second box-in-box structure. The box-in-box structure may be similar to one of the box-in-box structure 100 in FIG. 1 or in FIG. 2.

As shown in FIG. 10, a cell structure 200 and a cell structure 201 may be provided. A cell structure 200 may be physically connected to a cell structure 201 to form a cell assembly 200A. The cell structure 200 or the cell structure 201 may independently be a cell or a battery, for example an air cell or a fuel battery. The cell structure 200 may include a first module, a second module and a central module, for example a case 231, a central conductive sheet 236, a first outer conductive sheet 216, a first inner conductive sheet 217, a second outer conductive sheet 226 and a second inner conductive sheet 227. The first outer conductive sheet 216, the first inner conductive sheet 217, the central conductive sheet 236, the second outer conductive sheet 226 and the second inner conductive sheet 227 may be respectively used for the external electrical connection to another cell.

The cell structure 201 may include a first module, a second module and a central module, for example a case 231′, a central conductive sheet 236′, a second module film 222′, a first outer conductive sheet 216′, a first inner conductive sheet 217′, a second outer conductive sheet 226′ and a second inner conductive sheet 227′. The first outer conductive sheet 216′, the first inner conductive sheet 217′, the central conductive sheet 236′, the second outer conductive sheet 226′ and the second inner conductive sheet 227′ may be respectively used for the external electrical connection to another cell.

The cell structure 200 may be electrically connected to the cell structure 201 to form a cell assembly 200A. For example, the conductive sheets of the cell structure 200 may be electrically connected to the conductive sheets of the cell structure 201.

In one embodiment of the present invention, the cell structure 200 may be electrically connected to the cell structure 201 in parallel. In another embodiment of the present invention, the cell structure 200 may be electrically connected to the cell structure 201 in series.

Property Tests

Bonding Strength Test

The tests confirm that the film may keep a bonding strength, or adhesion, between the first box and the second box not less than 15 kg in accordance with IEC68-2-21 Test Ua1. Test results are given in Table 2.

Test condition of the thermal clay: 25 mm*25 mm*4 mm=2.5 cm³ (0.0025 liter)

Thermal clay used for the test: 0.0025 (PES or PPSU)−0.000313 (Material)=0.002187 liter (Two materials are used to maintain the position range of the component)

thermal clay: PES or PPSU

Dimension of metal strips (Material): 25 mm*25 mm*0.5 mm=0.313 cm³ (0.000313 liter) (IEC68-2-21Test Ua1)

TABLE 2

| | stainless | | | | aluminum |
|---|---|---|---|---|---|
| Materials | steel | Ni | Fe | brass | alloy |
| Results | pass | pass | pass | pass | pass |

Pass: bonding strength not less than 15 Kgf (147 nt).

The present invention provides the use of thermal clay to greatly enhance the mechanical strength between the interface of an organic polymer and a metallic material, further the use of the box-in-box structure in a fuel cell or in a cell assembly and a method to form a box-in-box structure. In some embodiments, the present invention proposes a novel box-in-box structure for use in a fuel cell or in a cell assembly with an excellent or stable mechanical property exhibited in the tests.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A box-in-box structure, comprising:
thermal clay being in a form of a first box and comprising a polyarysulfone material;
a plate; and
a film which has at least one side in a form of a second box to be attached to the first box in the presence of the thermal clay so that the first box accommodates the second box to form a box-in-box structure.

2. The box-in-box structure of claim 1, wherein the polyarysulfone material is selected from a group consisting of a polysulfone, a polyethersulfone and a polyphenylsulfone.

3. The box-in-box structure of claim 1, wherein the plate includes a metallic material, a filler and a catalytic material.

4. The box-in-box structure of claim 1, wherein the film is a perfluoropolymer organic film.

5. The box-in-box structure of claim 1, wherein the thermal clay is in direct contact with the film and with the plate to keep bonding strength between the first box and the second box not less than 15 kgf in accordance with IEC68-2-21 Test Ua1.

6. A method to form a box-in-box structure, comprising:
providing thermal clay in a form of a first box;
providing a film which has at least one side in a form of a second box; and
applying the thermal clay to attach a plate and the second box comprising a polyarysulfone material to the first box so that the second box is accommodated in the first box to forma first box-in-box structure.

7. The method to form a box-in-box structure of claim 6, wherein the thermal clay is applied by a fused deposition modeling printer.

8. The method to form a box-in-box structure of claim 7, wherein the thermal clay has a temperature from 300° C. to 400° C. and is softened to be printed.

9. The method to forma box-in-box structure of claim 7, wherein the thermal clay is applied and stacked on another thermal clay to form a thermal-clay-on-thermal-clay structure.

10. The method to form a box-in-box structure of claim 6, wherein an interface temperature between the first box and the second box is from 100° C. to 150° C.

11. The method to form a box-in-box structure of claim 6, further comprising:
providing a second box-in-box structure; and
combining the second box-in-box structure to the first box-in-box structure to form a cell.

12. The method to form a box-in-box structure of claim 11, wherein the cell comprises at least two box-in-box structures.

13. The method to form a box-in-box structure of claim 6, wherein heat-generating welding is performed to form the first box-in-box structure.

14. The method to form a box-in-box structure of claim 11, wherein an insert molding method is used to form the cell.

15. Use of the box-in-box structure of claim 1 in a fuel cell.

16. Use of thermal clay comprising a polyarysulfone material and a film in a fused deposition modeling printer for the formation of a box-in-box structure.
